(19) United States
(12) Patent Application Publication
(10) Pub. No.: US 2026/0111932 A1
(43) Pub. Date: Apr. 23, 2026

(54) IN-DEPLOYMENT VALUATION OF NETWORKING EQUIPMENT

(71) Applicant: Cisco Technology, Inc., San Jose, CA (US)

(72) Inventors: Chih-Tsung Huang, San Jose, CA (US); Christopher A. Weiland, DENVER, CO (US)

(21) Appl. No.: 18/919,320

(22) Filed: Oct. 17, 2024

(51) Int. Cl. G06Q 30/02; H04L 43/0876

(52) U.S. Cl. CPC G06Q 30/0278; G06F 11/3006; G06F 11/3055; G06F 11/3058; G06F 11/3409; H04L 43/0876

(57) ABSTRACT

Devices, systems, methods, and processes for determining the condition and valuation of a network device. Network devices operating in a networking environment like datacenters, etc. become aged or obsolete. Typically, the valuation of such network devices is determined using a disruptive process, where the network device is removed from the networking environment. To address these issues, a non-disruptive solution to determine the condition and valuation of the network devices is provided. Functional and physical utilization data for a set of components of the network device may be collected while the network device is operational. The valuation of each of the set of components may be assessed based on one or more valuation categories and the valuation of the network device may be determined based on the valuation of each of the set of components across at least one of the one or more valuation categories.

The present disclosure relates to network management. More particularly, the present disclosure relates to valuation of networking equipment while the networking equipment is in-deployment and operational.

### BACKGROUND

Networking equipment such as routers, switches, access points, servers, or the like are extensively used in datacenters, dense Wi-Fi networks, enterprise IT infrastructure, or the like. Over time, the networking equipment age, resulting in inefficiencies in energy consumption and routing. Additionally, advancement in technology, such as new standards and adaptation of new protocols, may require upgrades to networking equipment, rendering the older networking equipment redundant.

Enterprises and datacenters seeking to replace and resell outdated networking equipment face challenges with the current valuation processes. These processes are disruptive as they require the equipment to be removed from the network system to assess its quality and determine its value. This removal can interrupt network operations, making the process cumbersome and inefficient. Further, the removal of equipment requires the involvement of skilled technicians, adding complexity and making the process more person-dependent. Additionally, the testing involved is often expensive and customized to specific networking products, further complicating the valuation process.

### SUMMARY OF THE DISCLOSURE

Systems and methods for valuation of networking equipment while the networking equipment is in-deployment and operational in accordance with embodiments of the disclosure are described herein. In many embodiments, a network device, comprising a set of components, a processor, and a memory communicatively coupled to the processor, is provided. The memory comprises a valuation logic that is configured to collect utilization data of the set of components, assess, based on the utilization data, a valuation of each of the set of components across each of one or more valuation categories, and determine a valuation of the network device based on the assessed valuation of each of the set of components across at least one of the one or more valuation categories.

In a number of embodiments, the valuation of the network device corresponds to an aggregate of the valuation of each of the set of components.

In a variety of embodiments, determining the valuation of the network device comprises selecting, for each of the set of components, a minimum value from the valuation across each of the one or more valuation categories. The valuation of the network device is determined based on the selected valuation for each of the set of components.

In more embodiments, determining the valuation of the network device comprises applying, for each of the set of components, an aggregation function on the valuation across each of the one or more valuation categories, and obtaining an intermediate valuation for each of the set of components based on applying the aggregation function. The valuation of the network device is determined based on the intermediate valuation obtained for each of the set of components.

In additional embodiments, the aggregation function comprises at least one of a sum function, an average function, or a maximum function.

In further embodiments, the valuation logic is further configured to transmit the valuation of the network device to a graphical user interface (GUI) of a user device.

In still more embodiments, the one or more valuation categories comprises at least one of a use time value category, a mechanical value category, or a user-defined value category.

In still further embodiments, the utilization data of a component of the set of components comprises data associated with one or more functional parameters of the component.

In still additional embodiments, the one or more functional parameters of the component comprise at least one of a power up time period, a product up time period, or an over-heat temperature alarm time period.

In yet more embodiments, the utilization data of a component of the set of components comprises data related to one or more physical parameters of the component.

In still yet more embodiments, the utilization data of a component of the set of components comprises at least one of a count of insertion and removal instances of the component, a count of rotations of the component, or a rotation time period of the component.

In many further embodiments, the utilization data of a component of the set of components comprises data related to at least one of one or more environmental factors or user-defined criteria.

In many additional embodiments, the one or more environmental factors comprise at least one of a pressure, a humidity, an altitude, a temperature, or a geographical location of the component.

In still yet further embodiments, the valuation logic is further configured to receive new utilization data for the set of components, and update, based on the new utilization data, the assessed valuation of each of the set of components across each of the one or more valuation categories.

In still yet additional embodiments, the valuation logic is further configured to update the valuation of the network device based on the updated valuation of each of the set of components across each of the one or more valuation categories.

In several embodiments, the valuation logic is further configured to utilize a machine learning model to assess the valuation of each of the set of components across each of the one or more valuation categories.

In several more embodiments, the valuation logic is further configured to assess a use condition of each of the set of components based on the utilization data, and determine a remaining useful life of the network device based on the use condition of each of the set of components.

In numerous embodiments, the valuation logic is further configured to determine the valuation of the network device while the network device is in operation deployed in a networking system or environment.

In numerous additional embodiments, a device, comprising a processor, a transceiver communicatively coupled to a network device, and a memory communicatively coupled to the processor, is provided. The network device comprises a set of components. The memory comprises a valuation logic that is configured to receive utilization data of the set of components, assess, based on the received utilization data, a valuation of each of the set of components across each of one or more valuation categories, and determine a valuation of the network device, while the network device is in operation, based on the assessed valuation of each of the set of components across each of the one or more valuation categories.

In further additional embodiments, a method, comprising collecting utilization data of a set of components of a network device, assessing, based on the utilization data, a valuation of each of the set of components across each of one or more valuation categories, and determining a valuation of the network device based on the assessed valuation of each of the set of components across at least one of the one or more valuation categories, is provided.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram 100 of various environments in which a valuation logic may operate in accordance with various embodiments of the disclosure;

FIG. 2 is a conceptual illustration depicting a requirement for non-disruptive valuation determination of one or more network devices in a network in accordance with various embodiments of the disclosure;

FIG. 3A is a conceptual illustration of determining valuation of one or more network devices in a network environment in a non-disruptive manner in accordance with various embodiments of the disclosure;

FIG. 3B is a conceptual illustration of transmitting condition values of each network device to one or more other network devices in the network environment in a non-disruptive manner in accordance with various embodiments of the disclosure;

FIG. 3C is a conceptual illustration for transmitting the determined valuation of each network device to one or more other network devices in the network environment in a non-disruptive manner in accordance with various embodiments of the disclosure;

FIG. 4 is a conceptual illustration of a networking environment for determining valuation of one or more network devices in accordance with various embodiments of the disclosure;

FIG. 5 is a conceptual illustration of an artificial neural network in accordance with various embodiments of the disclosure;

FIG. 6 is a flowchart showing a process for determining valuation of a network device in accordance with various embodiments of the disclosure;

FIG. 7 is a flowchart showing a process for determining a remaining useful life of a network device in accordance with various embodiments of the disclosure;

FIG. 8 is a flowchart showing a process for determining valuation of a network device in accordance with various embodiments of the disclosure; and

FIG. 9 is a conceptual block diagram of a device suitable for configuration with a valuation logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide non-disruptive valuation of networking equipment. The solution discussed in the present disclosure provides a contactless and instantaneous assessment of both the condition and the value of the networking equipment. Generally, the networking equipment, for example, routers, switches, access points, servers, or the like deployed in datacenters, dense Wi-Fi networks, enterprise IT infrastructure, or the like tend to age over time. Consequently, requiring replacement or upgrades to align with new technology standards, protocols, etc. Enterprises seeking to replace and resell their outdated networking equipment may want to determine the resale value of the networking equipment.

However, the current valuation processes pose many challenges and limitations. For example, current valuation solutions rely on disruptive methods requiring the networking equipment to be removed from the network system. The removal of equipment often requires skilled technicians and can interrupt network operations. Additionally, valuation testing is often expensive, time-consuming, and customized to specific networking products, further complicating the valuation process. The current valuation solutions typically determine the valuation of the networking equipment based on the equipment's condition, with only limited data regarding equipment health and previous outages available, the results can be skewed.

To address the above issues, the present disclosure provides a data-driven solution that does not require network disruption. In many embodiments, a network may include a plurality of network devices such as routers, switches, firewalls, access points, hubs, or the like. Often, to ensure reliability and minimize downtime, redundancy is introduced in the network. This may involve having backup network devices and pathways to maintain functionality in case of a failure. However, sometimes network operators or enterprises may want to decrease redundancy. For example, if three redundant paths are deemed excessive in a network, the network operator may decide to remove one path and sell associated networking equipment. The choice between redundant paths could be based on factors such as device performance, device condition, and market valuation. There are many existing ways to determine device performance such as latency, so the challenge lies in deciding between paths when their performance is identical. In such situations, it may be required to determine the condition and valuation of the devices in each path, and that too without disrupting the network. In the present disclosure, the condition and valuation of a network device can be determined while the network device is operational and still in deployment.

In various embodiments, “condition” of a network device may refer to the state or quality of the network device at a specific time instance, often indicating how well the network device is functioning or how suitable the network device is for its intended purpose. In an example, the condition of a network device can be defined in terms of remaining useful life, mean time between failures, a health index, or the like. In a variety of embodiments, “valuation” of a network device may refer to the monetary value of the network device at a specific time instance. In order to determine the actual valuation of a network device, a real-time condition of the network device at the time of valuation must be known.

In more embodiments, the condition of the network device may be a function of use condition of a plurality of components in the network device. For example, the network device may include a plurality of components, such as a fan, one or more power supplies, one or more Central Processing Unit (CPU) cores, one or more transceivers, one or more flash disks, one or more Dual In-line Memory Modules (DIMMs), Light Emitting Diodes (LEDs), one or more batteries, one or more ports, chassis, one or more cooling systems, one or more linecards, one or more sensors, or other internal and external components. In some embodiments, the condition of the network device can be determined based on all components of the network device. However, in certain embodiments, the condition of the network device can be determined based on a set of high-valued components, components with higher failure, or components having higher use of the network device. Thus, to determine the condition of the network device a set of components from the plurality of components can be selected for evaluation. In an example scenario, the set of components can include CPU cores, DIMM, power supplies, fan and cooling systems, or other such high-valued components and may not include LEDs, cables, wiring, etc.

In further embodiments, utilization data of each of the selected set of components is collected. Utilization data of a component may include data related to one or more functional parameters, one or more physical parameters of the component, one or more environmental factors, or user-defined criteria. Examples of the functional parameters may include, but are not limited to, a power up time period, a product up time period, an over-heat temperature alarm time period, etc. Examples of the physical parameters may include, but are not limited to, a count of insertion and removal instances of the component, a count of rotations of the component, or a rotation period of the component. Examples of the environmental factors may include, but are not limited to, a pressure, a humidity, an altitude, a temperature, or a geographical location of the component. Different components can have different functional and physical parameters for which utilization data is collected. In additional embodiments, the utilization data for the set of components can be collected by a data recorder (e.g., a CPU, microcontroller, custom silicon, Field Programmable Gate Array (FPGA), etc.) on the network device or by a cloud server communicatively coupled to the network device.

In yet more embodiments, the use condition of each of the set of components may be assessed based on the utilization data. Further, a remaining useful life of the network device may be determined based on the use condition of each of the set of components. In an example scenario where the set of components includes a fan, the use condition (e.g., a remaining useful life, a mean time between failures, health index, etc.) of the fan can be assessed based on the utilization data, indicating a total count of fan rotations, and the maximum count of fan rotations allowed. Similarly, the use condition of other components of the network device may also be assessed. Further, the remaining useful life of the network device can be determined based on the use condition of each of the set of components.

In several embodiments, a valuation of each of the set of components across each of one or more valuation categories may be assessed based on the utilization data. The one or more valuation categories may include, for example, a use time value category, a mechanical value category, and a user-defined value category. In other words, the valuation may be determined against each of the one or more valuation categories for each of the set of components. For example, for each of the set of components, the use time value may be determined as a function of total product up time and the maximum use time allowed for the given component. Similarly, for a component having insertion and removal capabilities, the mechanical value may be determined as a function of a count of insertions and removals and a maximum count of insertions and removals allowed for the given component. Likewise, for a fan that can rotate, the mechanical value may be determined as a function of a count of rotations and the maximum count of rotations allowed for the fan. Additionally, for each of the set of components, the user-defined value may be determined as a function of total hours of user-defined criteria and the maximum hours of user-defined criteria allowed for the given component. Further, the valuation of the network device may be determined based on the assessed valuation of each of the set of components across at least one of the one or more valuation categories.

In still further embodiments, a minimum value from the valuations across the one or more valuation categories may be selected for each of the set of components and the valuation of the network device may be determined as an aggregate of the valuation of each of the set of components across the corresponding selected valuation category. In other words, the valuation of the network device may be determined based on the selected valuation for each of the set of components. In further additional embodiments, the valuation of the network device may be determined based on the valuation of the component having minimum valuation.

In several embodiments, for each of the set of components, an aggregation function can be applied on the valuation across each of the one or more valuation categories and an intermediate valuation for each of the set of components may be obtained based on applying the aggregation function. The aggregation function can be selected from a group of: a sum function, a minimum function, an average function, or a maximum function. Thereafter, the valuation of the network device may be determined based on the intermediate valuation obtained for each of the set of components. For example, the valuation of the network device can be determined as an aggregate of the intermediate valuation obtained for each of the set of components. In numerous additional embodiments, a machine learning model may be utilized to assess the valuation of each of the set of components across each of the one or more valuation categories.

In several more embodiments, the valuation of the network device may be transmitted to a graphical user interface (GUI) of a user device. In an example scenario, an operator or user of the network system may be able to visualize the condition and the valuation of the network device on the GUI. In numerous embodiments, the valuation of the network device may be updated based on receiving new utilization data for the set of components. For example, the utilization data for the set of components can be collected at periodic time intervals, random time intervals, or in real time and based on incremental changes in the utilization data, the valuation of the network device may be updated. Thus, the valuation of the network device may be available to the operator or the customer without causing any disruption to the network. Non-disruption of the network serves as an advantage as taking out any network device from the network can impact the service, especially when the actual condition of the network device is unknown. Since the present disclosure considers the cumulative utilization data of each of the set of components of the network device, the determined valuation is accurate and objective.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

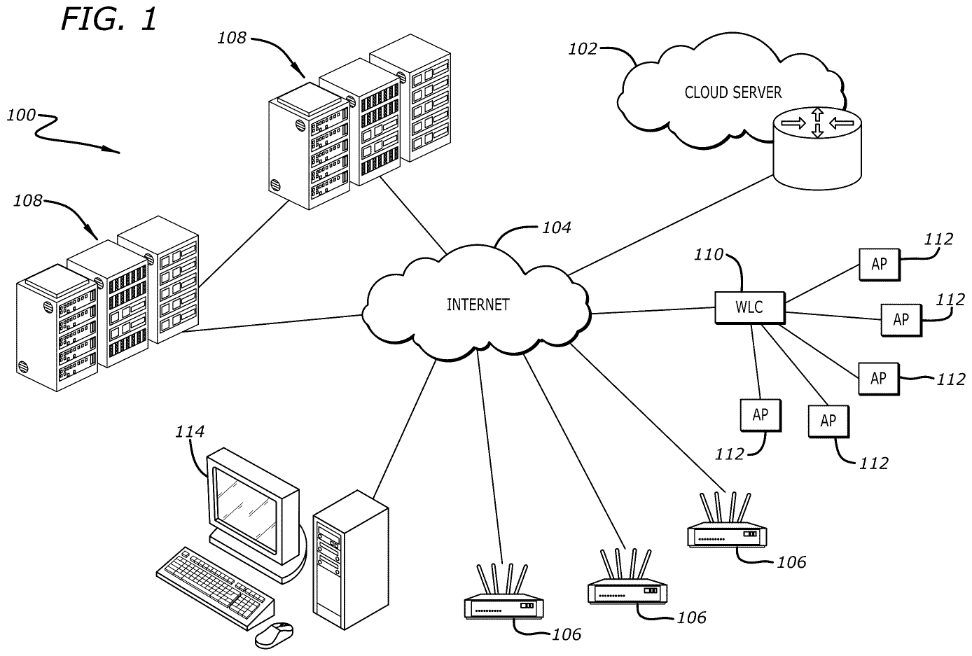

Referring to FIG. 1, a conceptual network diagram 100 of various environments in which a valuation logic may operate in accordance with various embodiments of the disclosure is shown. The valuation logic can include various hardware and/or software deployments and can be configured in a variety of ways. In many embodiments, the valuation logic can be configured as a standalone device, exist as a logic in another network device, be distributed among various network devices operating in tandem, or remotely operated as part of a cloud-based network management tool. In further embodiments, one or more servers 102 can be configured with the valuation logic or can otherwise operate as the valuation logic. In many embodiments, the valuation logic may operate on the one or more servers 102 connected to a communication network 104 (shown as the “Internet”). The communication network 104 can include wired networks or wireless networks.

However, in additional embodiments, the valuation logic may be operated as a distributed logic across multiple network devices. In the embodiment depicted in FIG. 1, a plurality of network access points (APs) 106 can operate as the valuation logic in a distributed manner or may have one specific device operate as the valuation logic for all of the neighboring or sibling APs 106. The APs 106 may be equipped with a data recorder residing on a secure vault of Central Processing Unit (CPU), microcontroller, custom silicon, Field-Programmable Gate Array (FPGA), or the like to determine the valuation of the respective APs 106. The APs 106 may facilitate Wi-Fi connections for various electronic devices, such as but not limited to, mobile computing devices including laptop computers, cellular phones, wearable computing devices, or the like. In still more embodiments, the valuation logic may operate on rack of switches 108 in a distributed manner.

In further embodiments, the valuation logic may be integrated within another network device. In the embodiment depicted in FIG. 1, a wireless LAN controller (WLC) 202C

may have an integrated valuation logic that the WLC 110 can use to monitor or visualize the condition and valuation of the APs 112 that the WLC 110 is connected to, either wired or wirelessly. In still more embodiments, a computer 114 may be utilized to access and/or manage various aspects of the valuation logic, either remotely or within the network itself. In the embodiment depicted in FIG. 1, the computer 114 communicates over the communication network 104 and can access the valuation logic of the servers 102, or the network APs 106, switches 108, or the WLC 110.

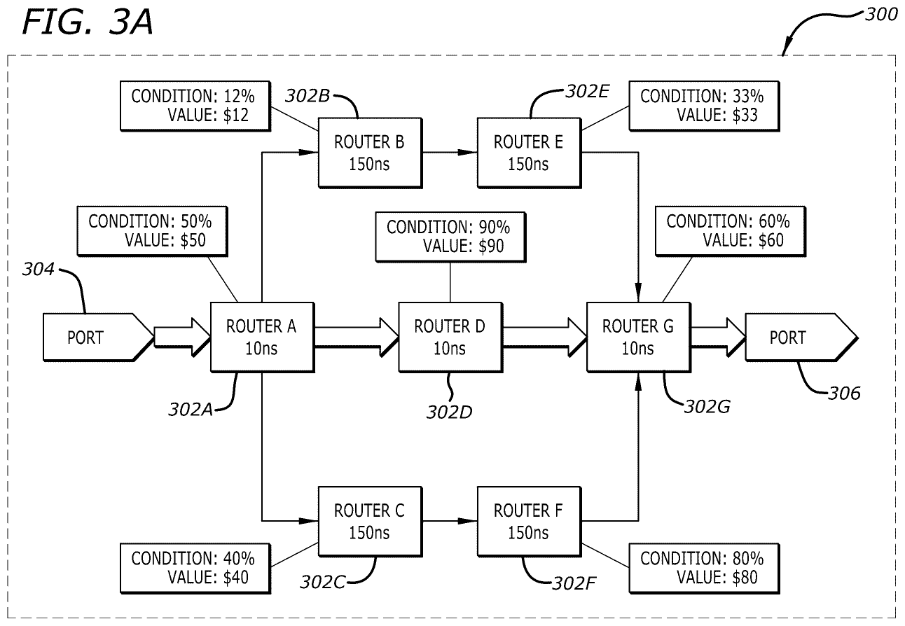

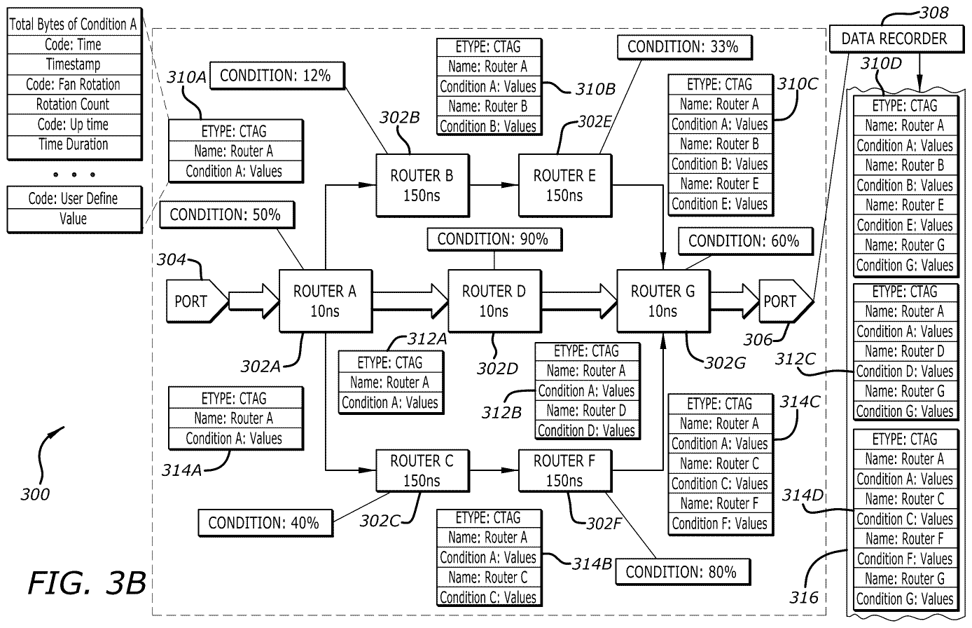

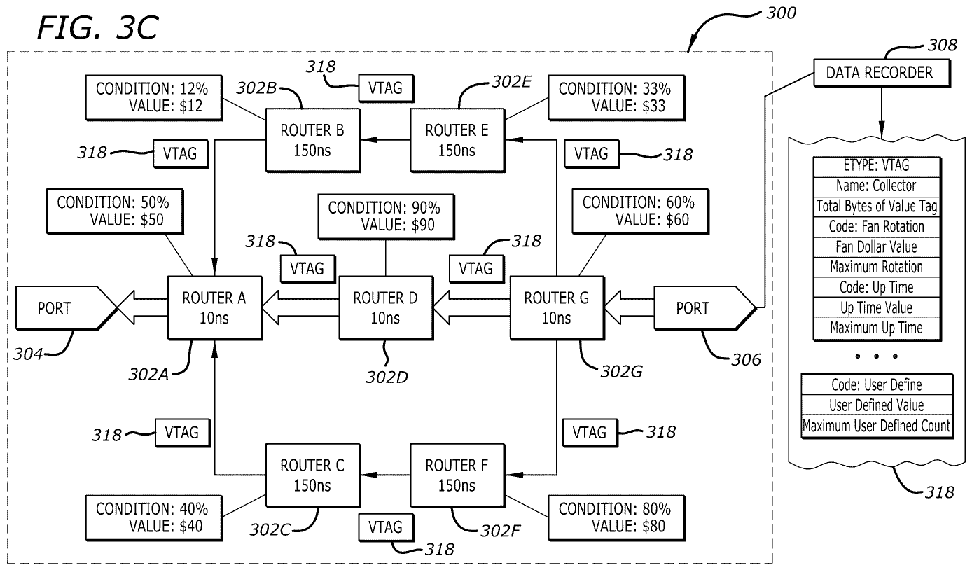

In several embodiments, a network may include a plurality of network devices such as routers, switches 108, firewalls, APs 106, the WLC 110, hubs, or the like. For any reason, such as upgrade or redundancy reduction, a network operator may decide to remove and sell one or more network devices. The valuation logic described above may determine the condition and valuation of network devices, and that too without disrupting the network. In other words, the valuation logic may be configured to determine the condition and valuation of the network device while the network device is operational and still in deployment within the network, i.e., without removing the network device from the network. Various operations of the valuation logic are described in detail in conjunction with FIGS. 3-9.

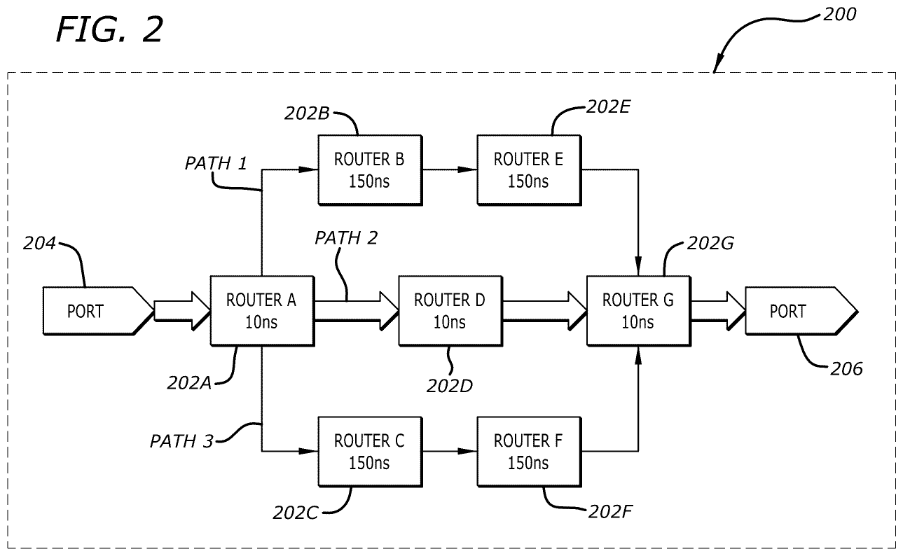

Although a specific embodiment for various environments that the valuation logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the valuation logic may be provided as a device or software separate from the WLC 110. The elements depicted in FIG. 1 may also be interchangeable with other elements of FIGS. 2-9 and as required to realize a particularly desired embodiment.

Referring to FIG. 2, a conceptual illustration depicting a requirement for non-disruptive valuation determination of one or more network devices in a network 200 in accordance with various embodiments of the disclosure is shown. The embodiment shown in FIG. 2 may depict a scenario where a plurality of network devices, such as routers 202A-202G may be deployed in the network 200.

In an example scenario shown in FIG. 2, the routers 202A-202G are deployed to provide three paths between connecting ports 204, 206. Ports 204, 206 can be utilized to provide physical as well as logical connectivity to network devices (e.g., the routers 202A-202G). In In an example, the ports 204, 206 can be Ethernet ports that connect the routers 202A-202G with other network devices such as switches, switches, end-user devices, or the like. In further examples, the ports 204, 206 can be Wide Area Network (WAN) ports that connect the routers 202A-202G to external networks, such as the Internet or other remote networks. As depicted in FIG. 2, each of the routers 202A-202G may have a respective latency associated with them. For example, the routers 202A-202G may be associated with latency values of 10 nanoseconds (ns), 150 ns, 150 ns, 10 ns, 150 ns, 150 ns, and 10 ns, respectively. Below table represents example latency determined across each of the three paths: Path 1, Path 2, and Path 3.

TABLE 1

Path 1: 202A -> 202B -> 202E -> 202G takes 320 ns
Path 2: 202A -> 202D -> 202G takes 30 ns
Path 3: 202A -> 202C -> 202F to 202G takes 320 ns

In an example scenario, a network operator of the network 200 may want to decrease redundancy. For example, if three redundant paths are deemed excessive in the network 200, the network operator may decide to remove one of the three paths, and sell associated routers, e.g., in secondary market. Based on path performance (e.g., path latency) shown in Table 1, the network operator can select any of Path 1 or Path 3 having identical latencies that are less than the latency of Path 2. Thus, the challenge lies in deciding between Path 1 and Path 3 as their performance is identical. Making a decision purely on device performance can lead to a random selection of which path to remove, which may not be an optimal approach. For example, the routers 202B and 202E may have less remaining useful life compared to the routers 202C and 202F, and therefore the actual valuation of the routers 202B and 202E may be less than the routers 202C and 202F. In such a scenario, if the network operator ends up removing Path 3 including the routers 202C and 202F, the resale value would be less. Thus, information on the condition (e.g., remaining useful life) and resale value (e.g., valuation) of the routers 202B, 202C, 202E, and 202F can aid in making the decision.

However, conventional valuation approaches and tools require a network device to be removed from a network for valuation purposes. Such removal and re-installation of the routers 202B, 202C, 202E, and 202F can disrupt the operations of the network 200. In the current example, at one point in time only one path can be removed for testing. Thus, making the testing process time-consuming and cumbersome. Further, it would require skilled technicians to remove and reinstall the routers 202B, 202C, 202E, and 202F in the network 200. In the present example, both Path 1 and Path 3 include similar networking equipment, which might not be the case all the time. In actual implementations, network paths can include diverse networking equipment, and when tools or testing solutions are customized to specific networking devices, the valuation process becomes more complicated.

Therefore, there is a need for a non-disruptive solution, which does not require a network device to be removed from the network for valuation purposes. A non-disruptive valuation solution is described in detail in conjunction with FIGS. 3-9.

Although a specific embodiment depicting a requirement for non-disruptive valuation with regards to redundancy reduction suitable for carrying out the various steps, processes, methods, and operations described herein is discussed with respect to FIG. 2, any of a variety of systems and/or processes may be utilized in accordance with embodiments of the disclosure. In several embodiments, the network 200 can include diverse networking equipment, for example, switches, firewall, servers, hubs, access points, or the like, and non-disruptive valuation may be required in other scenarios as well, for example, while implementing network level upgrades.

Referring to FIG. 3A, a conceptual illustration of determining valuation of one or more network devices in a network environment 300 in a non-disruptive manner in accordance with various embodiments of the disclosure is shown. The embodiment shown in FIG. 3A may depict a scenario where a plurality of network devices, such as routers 302A-302G, may be deployed in a network environment 300 between connecting ports 304, 306. Ports 304, 306 can be utilized to provide physical as well as logical connectivity to network devices (e.g., the routers 302A-302G). For example, the ports 304, 306 can be Ethernet ports, WAN ports, or other similar ports that connect the routers 302A-302G with other network devices or external networks. The scenario depicted in FIG. 3A describes an example embodiment of valuation of network devices deployed in the network environment 300 by a network operator or a customer. Here, the term “customer” may be used for any party interested in buying the network devices, such as routers 302A-302G, in a secondary resale market.

In many embodiments, a condition as well as a valuation of a network device (such as any of the routers 302A-302G) may be determined in a non-disruptive manner. Here “non-disruptive” may indicate that the network device may not be removed from the network environment 300 for the purposes of determining the condition and valuation. In other words, the condition and the valuation of the network device can be determined while the network device is in operation and deployed in the network environment 300. The term “condition” of a network device may refer to the state or quality of the network device at a specific time instance, often indicating how well the network device is functioning or how suitable the network device is for its intended purpose. In an example, the condition of a network device can be defined in terms of remaining useful life, mean time between failures, a health index, or the like. Further, the term “valuation” of a network device may refer to a monetary value associated with the network device at a specific time instance. In other words, valuation may refer to a worth of the network device, for example, for resale purposes.

In a number of embodiments, the network device may include a plurality of components such as fan, one or more power supplies, one or more Central Processing Unit (CPU) cores, one or more transceivers, one or more flash disks, one or more Dual In-line Memory Modules (DIMMs), Light Emitting Diodes (LEDs), one or more batteries, one or more ports, chassis, one or more cooling systems, one or more linecards, one or more sensors, or other internal and external components. In some embodiments, the condition of the network device (e.g., the routers 302A-302G) can be determined based on use condition of all components of the network device. However, in certain embodiments, the condition of the network device can be determined based on use condition of a set of high-valued components, components with higher failure, or components having higher use of the network device. Thus, to determine the condition of the network device, the set of components from the plurality of components can be selected for evaluation. In an example scenario, the set of components can include CPU cores, DIMM, power supplies, fan and cooling systems, or other such high-valued components and may not include LEDs, cables, wiring, etc.

In a variety of embodiments, utilization data for the set of components may be collected. The utilization data of a component may include data associated with one or more functional parameters, one or more physical parameters, one or more environmental factors, or user-defined criteria associated with the component. The one or more functional parameters of the component may refer to various operational attributes that define the capabilities, performance, and reliability characteristics of a component. Examples of the one or more functional parameters may include a power up time period, a product up time period, over-heat temperature alarm time period, first power up time, last power up time, or the like. The functional parameters may provide insights regarding the efficiency, stability, and resilience of the component under various operating conditions. In a similar manner, the one or more physical parameters may refer to mechanical functioning and operation of the components. Examples of the one or more physical parameters may include a count of insertion and removal instances of the component, a count of rotations of the component, a rotation time period of the component, or other such physical parameters. In an example scenario, a count of rotations of a component (such as a fan) can be collected to measure the physical integrity and operational stability of the component as frequent rotations may lead to loosening, wear of moving parts, and eventual failure of mechanical components. The one or more environmental factors may refer to external conditions and elements in a network device operating environment, and thus the components, that may influence performance, reliability, and lifespan of the network device. Examples of the environmental factors may include, but are not limited to, a pressure, a humidity, an altitude, a temperature, or a geographical location of the component. In an example scenario, high humidity levels can cause condensation, corrosion of components, and even short circuit. Similarly, components operating in extreme temperatures may suffer overheating or freezing of components, leading to malfunctions or permanent damage. Different components can have different functional and physical parameters for which utilization data is collected.

In still further embodiments, the utilization data may be collected by a data recorder residing on a secure vault of a Central Processing Unit (CPU) or microcontroller, custom silicon, FPGA, or the like, of the network device (e.g., any of the routers 302A-302G). In still additional embodiments, the data recorder may reside remotely on a cloud server. In yet more embodiments, the utilization data may be collected in a real-time manner by the data recorder. In still yet more embodiments, the utilization data may be stored in a memory unit of the network device and may be updated periodically on the CPU or the cloud server. In several embodiments, the utilization data may be collected by one or more sensors communicatively coupled with the set of components. The one or more sensors may collect the utilization data corresponding to the set of components and may provide the utilization data to the data recorder at periodic time intervals, random time intervals, or in real time. In further embodiments, the use condition of each of the set of components may be assessed based on the utilization data. In an example scenario, the use condition of a fan in the router 302A may be determined based on the maximum count of rotations for the fan as mentioned by a manufacturer and a total count of fan rotations the fan has undergone while in operation. Thus, use condition of the fan may be determined based on the collected utilization data. Similarly, the use condition of other components of the network device may also be assessed. In still more embodiments, the remaining useful life of the network device (e.g., any of the routers 302A-302G) may be determined based on the use condition of each of the set of components. In still yet more embodiments, the remaining useful life of the network device may be determined as the minimum of the remaining useful life of each of the set of components.

In more embodiments, valuation of each of the set of components across each of one or more valuation categories may be assessed. A valuation of each of the set of components across each of the one or more valuation categories may be assessed based on the utilization data. The one or more valuation categories may include, for example, a use time value category, a mechanical value category, or a user-defined value category. Use time value category may correspond to a valuation category in which valuation of a component is determined based on the utilization data related to the one or more functional parameters. For example, use time valuation of a fan in a three years old router may be less as compared to a fan in a one year old router. Mechanical value category may correspond to a valuation category in which valuation of a component is determined based on the utilization data related to the physical parameters. For example, for a component (such as a flash disk) that can be removed and reinserted in the network device, valuation for the mechanical value category may be determined based on factors such as the count of insertions or removals and a maximum count of insertions and removals allowed for the given component. Likewise, for a fan that can rotate, valuation for the mechanical value category may be determined based on factors such as the count of rotations and the maximum count of rotations allowed for the fan. Additionally, for each of the set of components, valuation for the user-defined value category may be determined as a function of total hours of user-defined criteria and the maximum hours of user-defined criteria allowed for the given component.

Any component when put to use suffers degradation due to normal wear and tear, and thus the valuation of the component may also be affected. In additional embodiments, valuations under the use time value category, the mechanical value category, the user-defined value category, or the like for a component may be assessed as per the original component value, for example, as shown in equations 1-5 below. The equations 1-5 are used as example, and any other suitable function can be utilized to determine the valuation of each of the set of components across the one or more valuation categories.

$$Use Time Value = {Value}_{Org} \times ( 1 - \frac{Component up time}{Maximum use time} ) \qquad ( 1 )$$

where,
‘Value_{org}’ may refer to original component value.

$$Use Time Value = {Value}_{Org} \times ( 1 - \frac{0.1 A + 0.2 B + 0.7 C}{Maximum use time} ) \qquad ( 2 )$$

where,
‘A’ may refer to time spinning below 20%;
‘B’ may refer to time spinning between 20% to 80%; and
‘C’ may refer to time spinning above 80%

$$Mechanical Value = {Value}_{Org} \times ( 1 - \frac{Count of insertion \& Removal}{Maximum insertion \& Removal} ) \qquad ( 3 )$$

$$Mechanical Value = {Value}_{Org} \times ( 1 - \frac{Count of rotation}{Maximum count of rotation} ) \qquad ( 4 )$$

$$User - Defined Value = {Value}_{Org} \times ( 1 - \frac{Hours of user - defined criteria}{Maximum hours of user - defined criteria} ) \qquad ( 5 )$$

In many further embodiments, the valuation of the network device (e.g., any of the routers 302A-302G) may be determined based on the assessed valuation of each of the set of components across at least one of the one or more valuation categories. In many additional embodiments, the valuation of the network device may correspond to an aggregate of the valuation of each of the set of components across at least one of the one or more valuation categories.

In still yet more embodiments, for each of the set of components, a minimum value from the valuations across the one or more valuation categories may be selected and the valuation of the network device may be determined as an aggregate of the selected valuation of each of the set of components. Here, aggregate may correspond to a sum of the selected valuations of each of the set of components. In further additional embodiments, the valuation of the network device may be determined based on the valuation of the component having minimum valuation.

In many further embodiments, for each of the set of components, an aggregation function can be applied on the valuations across the one or more valuation categories and an intermediate valuation for each of the set of components may be obtained based on applying the aggregation function. The aggregation function can be selected from a group of: a sum function, a minimum function, an average function, weighted average function, weighted sum function, or a maximum function. For example, if the sum function is selected, the intermediate valuation for a component may be the sum of valuations across the use time value category, the mechanical value category, and the user-defined value category. Likewise, if the average function is selected, the intermediate valuation for a component may be the average of valuations across the use time value category, the mechanical value category, and the user-defined value category. For example, for a component the weighted sum function can be selected. In such a scenario, the valuation across each of the one or more valuation categories is multiplied with a weight assigned to corresponding valuation category and then adding these products together to obtain the intermediate valuation for the component. In various embodiments, different aggregation functions can be applied to obtain intermediate valuations for different components. For example, for a fan, the average function can be applied on the valuations of the fan across the one or more valuation categories and for a flash disk, the minimum function can be applied on the valuations of the flash disk across the one or more valuation categories. Thereafter, the valuation of the network device may be determined based on the intermediate valuation obtained for each of the set of components. For example, the valuation of the network device may be determined based on an aggregate (e.g., sum, weighted sum, etc.) of the intermediate valuation obtained for each of the set of components. For example, different components may have varying contribution in the valuation of the network device. Thus, a weighted sum may be obtained by utilizing the intermediate valuation of each of the set of components and weights assigned to each of the set of components.

In many additional embodiments, the valuation of the network device may be transmitted to a graphical user interface (GUI) of a user device. In an example scenario, the network operator or user of the network system may be able to visualize the condition (e.g., the remaining useful life) and the valuation of each of the routers 302A-302G on the GUI, as depicted in FIG. 3A.

For example, as shown in FIG. 3A, the router 302B having a latency of 150 ns has only 12% of remaining useful life, while the router 302C with the identical latency has 40% of remaining useful life. Further, the router 302E having a latency of 150 ns has 33% of remaining useful life, while the router 302F with the identical latency has 80% of remaining useful life. Based on the assessed conditions, the router 302B is valued at $12, the router 302C is valued at $40, the router 302E is valued at $33, and the router 302F is valued at $80. The network operator may take resale and device upgrade decisions based on the condition (e.g., the remaining useful life) and the valuation of each of the routers 302A-302G.

In still yet further embodiments, the valuation of the network device may be updated based on receiving new utilization data for the set of components. For example, the utilization data for the set of components can be collected at periodic time intervals, random time intervals, or in real time. Based on the received new utilization data or incremental changes in the utilization data, the condition and the valuation of the network device can be determined and updated on the GUI.

Although a specific embodiment for determining valuation of one or more network devices in a non-disruptive manner suitable for carrying out the various steps, processes, methods, and operations described herein is discussed with respect to FIG. 3A, any of a variety of systems and/or processes may be utilized in accordance with embodiments of the disclosure. In several embodiments, a trained machine learning model may be utilized to assess the valuation of each of the set of components across each of the one or more valuation categories. For example, the collected utilization data of the set of components may be denoised and normalized and provided as input to the trained machine learning model and the machine leaning model may provide as outputs the valuations of the set of components and/or the valuation of the network device. The machine learning model may have been trained using a utilization dataset and valuation dataset of known components and network devices. During training, the machine learning model may learn weights for different functional, physical, environment, and user-defined parameters and weights for different components as per the contribution to the overall valuation of the network device. The elements depicted in FIG. 3A may also be interchangeable with other elements of FIGS. 1-2, 3B, 3C, and 4-9 as required to realize a particularly desired embodiment.

Referring to FIG. 3B, a conceptual illustration of transmitting condition values of each network device to one or more other network devices in the network environment 300 in a non-disruptive manner in accordance with various embodiments of the disclosure is shown. Considering the network environment 300 as explained above with respect to the FIG. 3A, in many embodiments, each of the network devices (e.g., the routers 302A-302G) may be configured to transmit the respective use condition to succeeding network devices operational in a network path. Thus, every operational network device in the network path may store its use condition value as well as use condition values of other preceding network devices operational in the network path. In an example scenario considering a network path having four routers (e.g., the routers 302A, 302B, 302E, and 302G), the router 302A may store and transmit its use condition value to the next router 302B in the network path. In a variety of embodiments, the network devices (e.g., routers 302A-302G) may store the use condition values in a packet format that can be distinctively transmitted through the network path to succeeding network devices. For example, transmitting such packets can include streaming inband network telemetry via addition of a Condition Tag (denoted as “CTAG” in FIG. 3B). The Condition Tag can be utilized to distinguish between packets carrying use condition values and packets carrying other communication data.

In an example scenario, the router 302A may store a Condition Tag 310A including information such as the name of the router, timestamp of transmitting or receiving the Condition Tag, a set of components of the router 302A, respective utilization data of the set of components, or other such relevant information. As shown in FIG. 3B, the Condition Tag 310A can include information related to one or more physical parameters of the components, such as fan rotation and the corresponding utilization data as ‘rotation count’, one or more functional parameters such as a component up time period, or the like, for the router 302A. In more embodiments, the router 302A may transmit the Condition Tag 310A to the router 302B. In a number of embodiments, the network device, upon receiving the use condition value of the preceding network device, may collate the received use condition value and its use condition value in the same packet format for forwarding to the network device in the network path. For example, the router 302B may append its use condition value to the received Condition Tag 310A to generate a new Condition Tag 310B. The Condition Tag 310B, therefore, includes the use condition values of the router 302B and the use condition value of the router 302A. Further, the router 302B may transmit the collated Condition Tag 310B to the next router 302E in the network path. Likewise, the router 302E may forward collated use condition values of the routers 302A, 302B, and 302E in a Condition Tag 310C to the router 302G, which in turn can transmit collated use condition values of the entire network path in a Condition Tag 310D to a data recorder 308 for normalization. In a similar manner, for another network path of the network environment 300, the routers 302A, 302D, and 302G may generate Condition Tags 312A, 312B, and 312C, respectively. As explained earlier in reference to the collated use condition values, the router 302D may collate the use condition values of the routers 302A and 302D and may forward collated Condition Tag 312B to the router 302G, which in turn may forward collated Condition Tag 312C to the data recorder 308 for normalization. Similarly, for another network path of the network environment 300, routers 302A, 302C, 302F, and 302G may generate Condition Tags 314A, 314B, 314C, and 314D, respectively. The Condition Tag 314D may refer to collated use condition values of the routers 302A, 302C, 302F, and 302G and can be forwarded to the data recorder 308 for normalization.

In further embodiments, the data recorder 308 may store the use condition values of each of the network devices (e.g., the routers 302A-302G) operational in the network environment 300. The data recorder 308 may store the use condition values of each of the routers 302A-302G as the collated Condition Tags 310D, 312C, and 314D. In still more embodiments, the data recorder 308 may normalize the use condition values of each of the network devices and store normalized use condition values 316. Normalization may include steps to process data packets indicating collated use condition values to ensure consistency and uniformity of the use condition values. For example, normalization can include ensuring consistency in the use condition values of network devices spread across different network paths. Considering the network environment 300 of FIG. 3B, the data recorder 308 may receive the use condition values of the router 302A via all three network paths in the Condition Tags 310D, 312C, and 314D. Thus, the data recorder 308 may verify the use condition values of the router 302A across all three Condition Tags 310D, 312C, and 314D for uniformity, consistency, missing values, or the like.

Although a specific embodiment depicting transmission of condition values of each network device to one or more other network devices in a network environment in a non-disruptive manner suitable for carrying out the various steps, processes, methods, and operations described herein is discussed with respect to FIG. 3B, any of a variety of systems and/or processes may be utilized in accordance with embodiments of the disclosure. In still additional embodiments, the data recorder 308 may broadcast the normalized use condition values to every network device operating in the network environment 300. This may ensure that all the network devices are consistent with the condition of every other network device in the network environment 300. The elements depicted in FIG. 3B may also be interchangeable with other elements of FIGS. 1-3A, 3C, and 4-9 as required to realize a particularly desired embodiment.

Referring to FIG. 3C, a conceptual illustration for transmitting the determined valuation of each network device to one or more other network devices in the network environment 300 in a non-disruptive manner in accordance with various embodiments of the disclosure is shown. Continuing with the scenario depicting the network environment 300 as explained above in FIGS. 3A and 3B, the data recorder 308 may determine the valuation of each of the network devices (e.g., routers 302A-302G). In many embodiments, the data recorder 308 may determine and collate the valuation of each of the network devices based on the use condition values of the respective network devices, as provided by collated Condition Tags. The process of determining the valuation of a network device has been explained above in reference to the FIG. 3A.

In a number of embodiments, the data recorder may normalize the collated valuation data of the network devices and transmit the collated valuation data to each of the network devices. The data recorder 308 may transmit the collated valuation data in a specialized packet format (for example, a Valuation Tag “VTAG” 318) via a reverse network path. For example, the data recorder 308 may transmit the VTAG 318 including the collated valuation data to the router 302G, which can transmit the VTAG 318 to the router 302D and subsequently to the router 302A in the network path. Similarly, the router 302G can also transmit the VTAG 318 to the routers 302E and 302F for propagation within respective network paths. Thus, each of the network devices operating in the network environment 300 may be equipped with the knowledge of the valuation of every other network device. In an example, the VTAG 318 may include information related to the valuation for the set of components of each of the network device. For example, the VTAG 318 can store information related to one or more physical parameters of the components of a network device, (such as fan rotation), the corresponding dollar value of the components, and maximum utilization value for the components, or the like. Likewise, the VTAG 318 may include information for other physical parameters, one or more functional parameters, user-defined parameters, or the like, and the corresponding valuation for the set of components of each of the network device.

Although a specific embodiment depicting transmitting valuation parameters of each network device to one or more network devices in a network environment in a non-disruptive manner suitable for carrying out the various steps, processes, methods, and operations described herein is discussed with respect to FIG. 3C, any of a variety of systems and/or processes may be utilized in accordance with embodiments of the disclosure. In more embodiments, the valuation of each of the network devices (such as routers 302A-302G) may be transmitted to a graphical user interface (GUI) of a user device, thus facilitating a network operator to visualize the valuation of each of the network devices on the GUI. The elements depicted in FIG. 3C may also be interchangeable with other elements of FIGS. 1-3A, 3B, and 4-9 as required to realize a particularly desired embodiment.

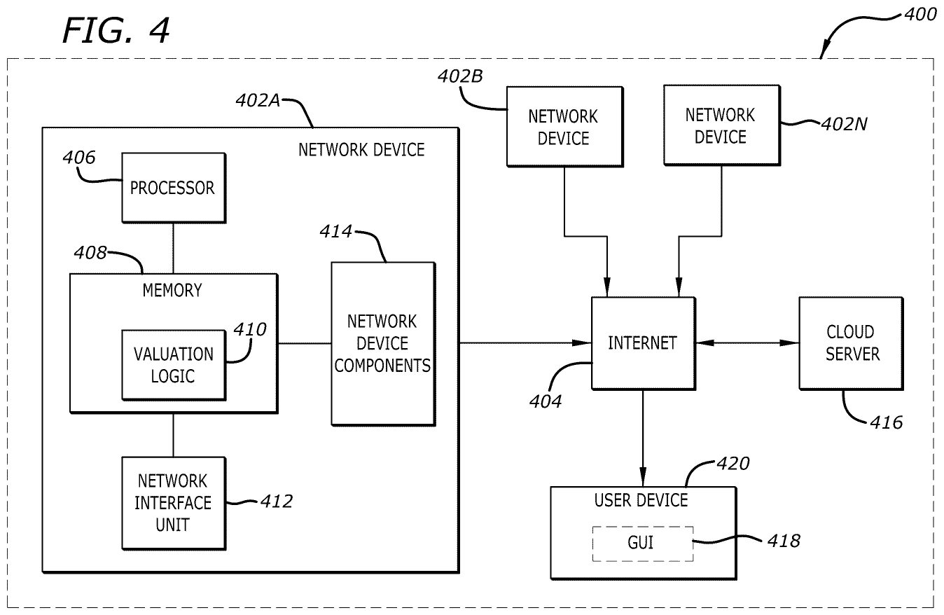

Referring to FIG. 4, a conceptual illustration of a networking environment 400 for determining valuation of one or more network devices in accordance with various embodiments of the disclosure is shown. In many embodiments, the networking environment 400 may have a plurality of network devices 402A-402N in operational state. The network devices 402A-402N may include routers, switches, access points, servers, or the like deployed in datacenters, dense Wi-Fi networks, enterprise IT infrastructure, or the like.

In a number of embodiments, the network device 402A may include a processor 406, a memory 408, a network interface unit 412, and other network device components 414. Examples of the processor 406 may include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), a Digital Signal Processor (DSP), or the like. In a variety of embodiments, the processor 406 may include a data recorder residing on a secure vault of the processor 406. The data recorder may collect utilization data of a set of network device components 414. The network devices components 414 may include various internal and external components of the network device such as fan, power supply, CPU cores, transceiver, flash disk, DIMM, LED, battery, etc.

In more embodiments, the memory 408 may be communicatively coupled to the processor 406 and may include a valuation logic 410. The valuation logic 410 may have definitions of one or more valuation categories and one or more aggregation functions using which the condition (also referred to as the “remaining useful life”) and the valuation of the network device 402A or other network devices 402B-402N may be determined.

The memory 408 may include any non-transitory storage device including, for example, volatile memory such as random-access memory (RAM), a read-only memory (ROM), or non-volatile memory such as EPROM, a hard disk drive (HDD), a flash memory, a solid-state memory, and the like. It will be apparent to a person skilled in the art that the scope of the disclosure is not limited to realizing the memory 408 in the network device 402A, as described herein. In additional embodiments, the memory 408 may be realized in form of a database server or a cloud server 416 working in conjunction with the network devices 402A-402N without departing from the scope of the disclosure. In a similar manner, other network devices 402B-402N may also include a processor, a memory, a network interface unit, and other network device components, with similar functions as explained in reference to the network device 402A.

In further embodiments, the network interface unit 412 may be configured to provide access to a network (for example, Internet 404 or a wired network). The network devices 402A-402N may be connected to a user device 420, having a graphical user interface (GUI) 418, to access and/or manage various aspects of the valuation logic 410. The GUI 418 may be configured to display the condition and/or the valuation of each of the network devices 402A-402N based on the valuation of the network devices 402A-402N by the valuation logic 410.

In still more embodiments, the valuation logic 410 may collect utilization data from the network device components 414. In still further embodiments, the valuation logic 410 may collect the utilization data for only network device components 414 of higher value, components with higher failure rate, or components having higher use. The network device components 414 that are utilized for condition and value assessment are hereinafter referred to as “set of components”. In still additional embodiments, the valuation logic 410 may assess a use condition and valuation of each of the set of components.

In yet more embodiments, the valuation logic 410 may determine the valuation of the network device 402A as an aggregate of the valuation of each of the set of components. In still yet more embodiments, the valuation logic 410 may apply an aggregation function on the valuation of each of the set of components across each of the one or more valuation categories. The valuation logic 410 may thus obtain an intermediate valuation for each of the set of components based on applying the aggregation function. For example, the valuation logic 410 may use a sum function, an average function, a maximum function, or a minimum function on the valuation of each of the set of components across each of the one or more valuation categories. Taking an example of fan, the one or more valuation categories may be a use time value category, a mechanical value category, or a user-defined value category. For the component fan, for each of the mentioned one or more valuation categories, the valuation logic 410 may determine a valuation. It might be the case that the valuation for the use time value category may be less than the valuations for the mechanical value or the user-defined value categories. Thus, the valuation logic 410 may select the minimum valuation, that is the valuation for the use time value category, for the fan. Similar valuation process may be performed for other remaining components of the set of components. In many further embodiments, the valuation logic 410 may thus determine the valuation of the network device 402A based on the intermediate valuation obtained for each of the set of components.

Although a specific embodiment depicting networking environment for determining valuation of one or more network devices suitable for carrying out the various steps, processes, methods, and operations described herein is discussed with respect to FIG. 4, any of a variety of systems and/or processes may be utilized in accordance with embodiments of the disclosure. In still more embodiments, the valuation logic 410 may operate on a cloud server. Thus, the cloud server may receive utilization data of the set of components from one or more connected network devices. The valuation logic 410 may thereafter determine the valuation of the one or more network devices based on the assessed valuation of each of the respective set of components. The elements depicted in FIG. 4 may also be interchangeable with other elements of FIGS. 1-3 and 5-9 as required to realize a particularly desired embodiment.

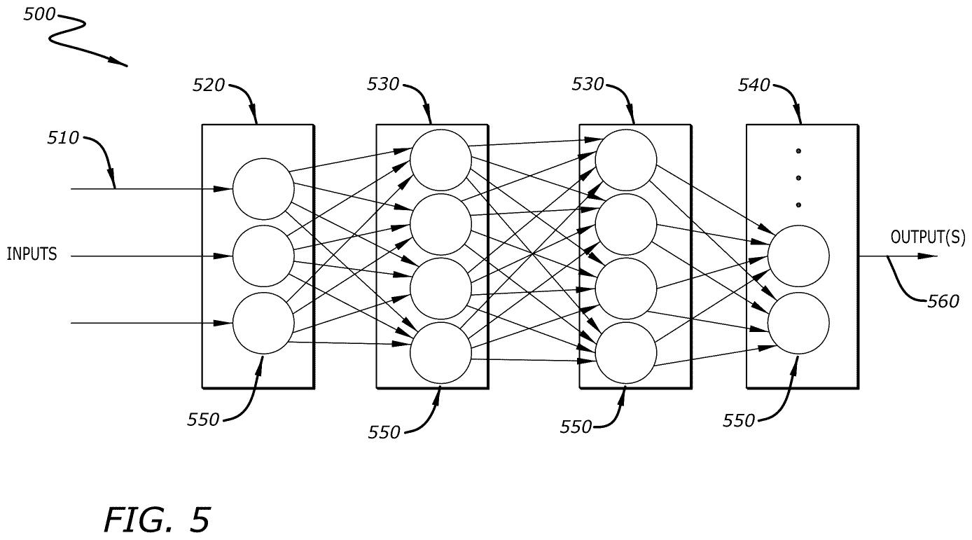

Referring to FIG. 5, a conceptual illustration of an artificial neural network 500 in accordance with various embodiments of the disclosure is shown. As those skilled in the art will recognize, various methods of machine learning models can be utilized to achieve desired outcomes efficiently. For example, some embodiments may utilize decisions trees, random forests, support vector machines, naïve Bayes, or K-nearest neighbors algorithms. However, artificial neural networks have increased in popularity, especially in deep learning techniques where detection of complex patterns in data and the ability to solve a wide range of problems has been desired. In various embodiments, an artificial neural network may be utilized. Artificial neural networks are a type of machine learning model inspired by the structure and function of the human brain, and often consist of three main types of layers: the input layer, the output layer, and one or more intermediate (also called hidden) layers.

In many embodiments, the input layer is responsible for receiving input data, which could be anything from an image to a text document to numerical values. Each input feature can be represented by a node in the input layer. Conversely, the output layer is often responsible for producing the output of the network, which could be, for example, a prediction or a classification. The number of nodes in the output layer can depend on the task at hand. For example, if the task is to classify images into ten different categories, there would be ten nodes in the output layer, each representing a different category.

The intermediate layers are where the specialized connections are made. These intermediate layers are responsible for transforming the input data in a non-linear way to extract meaningful features that can be used for the final output. In various embodiments, a node in an intermediate layer can take as an input a weighted sum of the outputs from the previous layer, apply a non-linear activation function to it, and pass the result on to the next layer. The weights of the connections between nodes in the layers are learned during training. This training can utilize backpropagation, which may involve calculating the gradient of the error with respect to the weights and adjusting the weights accordingly to minimize the error.

At a high level, the artificial neural network 500 depicted in the embodiment of FIG. 5 includes a number of inputs 510, an input layer 520, one or more intermediate layers 530, and an output layer 540 to provide one or more outputs 560. The artificial neural network 500 may comprise a collection of connected units or nodes called artificial neurons 550, which loosely model the neurons in a biological brain. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the artificial neural network 500 depicted in FIG. 5 is shown as an illustrative example, and various embodiments may comprise artificial neural networks that can accept more than one type of input and can provide more than one type of output.

In a number of embodiments, the signal at a connection between artificial neurons may be a value, such as utilization data of a set of components of a network device. The output of each artificial neuron may be computed by some nonlinear function (called an activation function) of the sum of the artificial neuron's inputs. Often, the connections between artificial neurons are called “edges” or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals propagate from the first layer (the input layer 520) to the last layer (the output layer 540), possibly after traversing one or more intermediate layers (also called hidden layers) 530.

The inputs to an artificial neural network may vary depending on the problem being addressed. To determine the valuation of a network device, in an example scenario, the input data provided to the artificial neural network 500 may include utilization data collected for a set of components of the network device. In a variety of embodiments, the artificial neural network 500 may comprise a series of hidden layers in which each neuron is fully connected to neurons of the next layer. The artificial neural network 500 may utilize an aggregation function on the valuation of the set of components across each of one or more valuation categories and determine the valuation of the network device. The last layer in the artificial neural network may implement a function to produce the classified or predicted classifications output for the valuation of the network device. Here, the classified or predicted classifications output may correspond to the remaining useful life (e.g., the condition) and the valuation of the network device. In several embodiments, the artificial neural network 500 can be trained based on the utilization data of network devices whose condition and valuation are known.

In several embodiments, the artificial neural network 500 can run locally on the network device for determining the condition and the valuation of the network device. In several additional embodiments, the artificial neural network 500 can run on a cloud or a remote server communicatively coupled to the network device. Further, the artificial neural network 500 may be implemented as a valuation logic for determining the condition and the valuation of the network device.

Although a specific embodiment for an artificial neural network machine learning model suitable for carrying out the various steps, processes, methods, and operations described herein is discussed with respect to FIG. 5, any of a variety of systems and/or processes may be utilized in accordance with embodiments of the disclosure. In several embodiments, for example, the artificial neural network may be externally operated, such as through a cloud-based service, or a third-party service. The elements depicted in FIG. 5 may also be interchangeable with other elements of FIGS. 1-4 and 6-9 as required to realize a particularly desired embodiment.

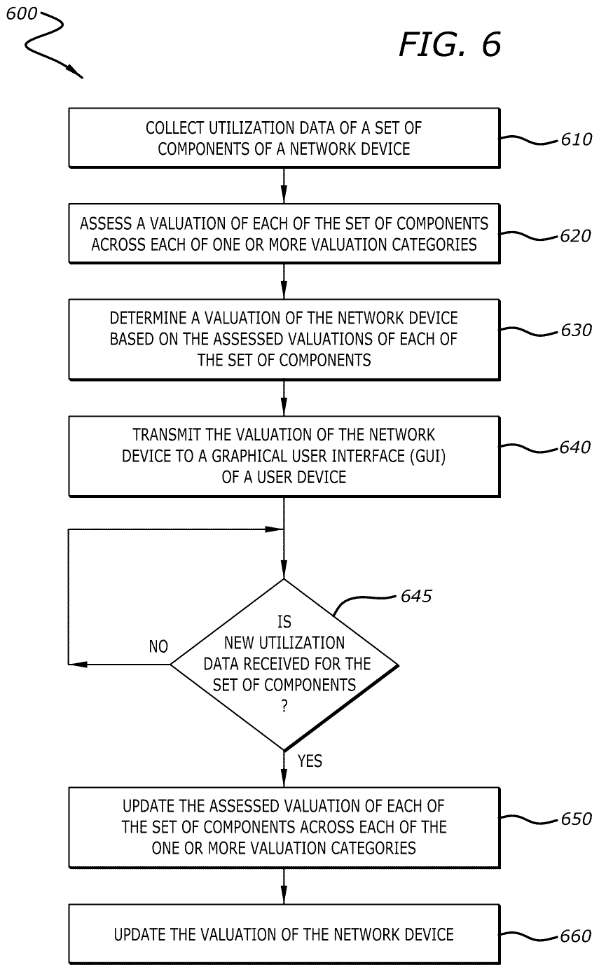

Referring to FIG. 6, a flowchart showing a process 600 for determining valuation of a network device in accordance with various embodiments of the disclosure is shown. In many embodiments, the process 600 may collect utilization data of a set of components of a network device (block 610). In numerous embodiments, the process 600 may be executed on the network device by way of a valuation logic. The network device may refer to any networking equipment such as routers, access points, switches, or the like. The components of the network device may include one or more internal and external components of the network device such as a fan, a power supply, CPU cores, transceiver, flash disk, battery, or the like. In several embodiments, the process 600 may collect the utilization data by way of a data recorder residing on a secure vault of a CPU, microcontroller, custom silicon, FPGA, or the like, on the network device. The network device may include one or more sensors communicatively coupled with the set of components. The one or more sensors may record the utilization data corresponding to the set of components and may provide the utilization data to the process 600. In many embodiments, the utilization data of a component of the set of components may include data related to one or more functional parameters or one or more physical parameters of the component. Examples of the functional parameters may include parameters such as a power up time period, a product up time period, an over-heat temperature alarm time period, or the like. Examples of the physical parameters may include parameters such as a count of insertion and removal instances of the component, a count of rotations of the component, a rotation time period of the component, or the like. In a number of embodiments, the utilization data may further include data related to at least one or more environmental factors or user-defined criteria. The one or more environmental factors may include a pressure, a humidity, an altitude, a temperature, or a geographical location of the component. For example, a network device operating in a colder region having temperatures close to sub-zero range may have CPU cores more prone to failures than the one operating in moderate climate. Thus, the condition and valuation for the same make and model of the network device may vary depending upon the geographical location or other environmental factors the network device is exposed to. In another example scenario, a network operator may select the set of components or criteria based on which the valuation of the network device may be determined. The network operator may put a condition that only the network devices older than two years may be selected for valuation determination.

In a number of embodiments, the process 600 may assess a valuation of each of the set of components across each of one or more valuation categories (block 620). The one or more valuation categories may include a use time value category, a mechanical value category, or a user-defined value category. The valuation of the network device may be determined as a function of original value of the network device and at least one valuation category. For example, a network device with 90% of use time can result into lesser use time value compared to a network device with only 30% of use time. In more embodiments, the valuation of each of the set of components, such as fan, CPU cores, power supply, etc. may be assessed across each of the one or more valuation categories, such as the use time value category, the mechanical value category, or the user-defined value category.

In a variety of embodiments, the process 600 may determine a valuation of the network device based on the assessed valuations of each of the set of components (block 630). The process 600 may assess the valuation of each of the set of components across each of the one or more valuation categories. In an example, the process 600 may select a minimum value from the valuation of each of the one or more valuation categories for each of the set of components. The process 600 may thus determine the valuation of the network device by aggregating the selected minimum valuation of each of the set of components. In additional embodiments, the valuation of the network device may be determined by applying an aggregation function on the valuation of the each of the set of components across each of the one or more valuation categories. The aggregation function may be selected from at least one of: a sum function, a minimum function, a weighted sum function, an average function, a weighted average function, a maximum function, or the like.

In further embodiments, the process 600 may transmit the valuation of the network device to a graphical user interface (GUI) of a user device (block 640). The process 600 may transmit the valuation of the network device to the user device for quick evaluation by a network operator. The network operator may thus be equipped with real-time information regarding the condition or valuation of the network device.

In still more embodiments, the process 600 may determine whether new utilization data is received for the set of components (block 645). Over time, the network device may generate new utilization data regarding the one or more functional parameters, the one or more physical parameters, the one or more environmental factors, or new user-defined criteria. If the new utilization data is received for the set of components, in still further embodiments, the process 600 may update the assessed valuation of each of the set of components across each of the one or more valuation categories (block 650). As the new utilization data may pertain to each of the set of components, the valuation across each of the one or more valuation categories may need to be updated.

In still additional embodiments, the process 600 may update the valuation of the network device (block 660). Based on the updated valuation of each of the set of components, the updated valuation of the network device may be determined as an aggregate (e.g., sum, weighted sum, or the like) of the valuation of each of the set of components. In several embodiments, the process 600 may transmit the updated valuation of the network device to the graphical user interface (GUI) of the user device. However, if no new utilization data for the set of components is received, the process 600 may continue to monitor whether new utilization data is received (block 645).

Although a specific embodiment showing a process for determining the valuation of a network device suitable for carrying out the various steps, processes, methods, and operations described herein is discussed with respect to FIG. 6, any of a variety of systems and/or processes may be utilized in accordance with embodiments of the disclosure. In yet more embodiments, the aggregation function may use a combination of two or more functions to determine an intermediate valuation for each of the set of components. The elements depicted in FIG. 6 may also be interchangeable with other elements of FIGS. 1-5 and 7-9 as required to realize a particularly desired embodiment.

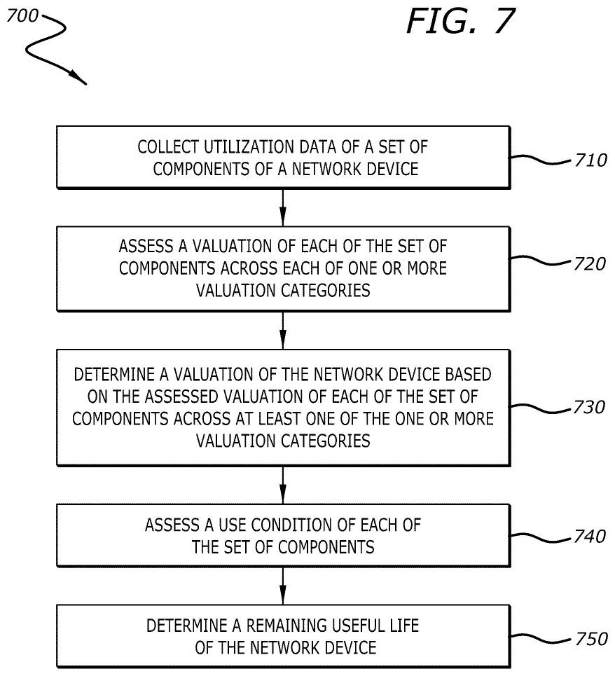

Referring to FIG. 7, a flowchart showing a process 700 for determining a remaining useful life of a network device in accordance with various embodiments of the disclosure is shown. In many embodiments, the process 700 may collect utilization data of a set of components of a network device (block 710). The utilization data of a component of the set of components of the network device may refer to one or more functional parameters or one or more physical parameters of the component.

In a number of embodiments, the process 700 may assess a valuation of each of the set of components across each of one or more valuation categories (block 720). The one or more valuation categories may include a use time value category, a mechanical value category, or a user-defined value category. The valuation of the network device may be determined as a function of original value of the network device and various valuation categories.

In a variety of embodiments, the process 700 may determine a valuation of the network device based on the assessed valuation of each of the set of components across at least one of the one or more valuation categories (block 730). The process 700 may apply an aggregation function on the valuation across each of the one or more valuation categories for each of the set of the components. Thus, an intermediate valuation for each of the set of components may be obtained. The process 700 may determine a valuation of the network device based on an aggregate of the intermediate valuation of each of the set of components.

In more embodiments, the process 700 may assess a use condition of each of the set of components (block 740). The process 700 may assess a use condition of each of the set of components based on the utilization data. The process 700 may assess various functional or physical parameters of each of the set of components. For example, the process 700 may assess total network device up time, first power up time, total hours of fan rotation, total count of fan rotation, and other similar data. The process 700 may also assess any changes in the environmental factors, such as change in operating temperature, levels of CO₂ emissions, humidity level, etc.

In additional embodiments, the process 700 may determine a remaining useful life of the network device (block 750). The process 700 may determine the remaining useful life of the network device based on the use condition of each of the set of components. In further embodiments, the process 700 may select a minimum value of the remaining useful life from the use condition of each of the set of components. The network device's condition may be as good as the condition of the worst performing component. Thus, the process 700 may determine the remaining useful life from the use condition of each of the set of components.

Although a specific embodiment showing a process for determining a remaining useful life of a network device suitable for carrying out the various steps, processes, methods, and operations described herein is discussed with respect to FIG. 7, any of a variety of systems and/or processes may be utilized in accordance with embodiments of the disclosure. In still further embodiments, the process 700 may transmit the condition of the network device to a GUI of a user device. In still additional embodiments, the condition of the network device may be represented as a remaining useful life on the GUI. The elements depicted in FIG. 7 may also be interchangeable with other elements of FIGS. 1-6 and 8-9 as required to realize a particularly desired embodiment.

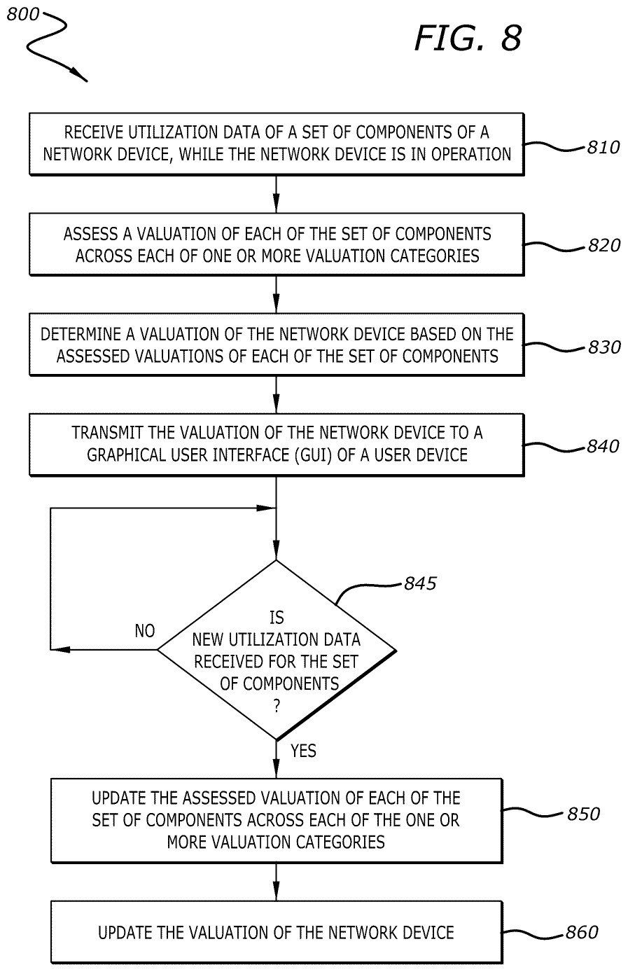

Referring to FIG. 8, a flowchart showing a process 800 for determining valuation of a network device in accordance with various embodiments of the disclosure is shown. In many embodiments, the process 800 may receive utilization data of a set of components of a network device, while the network device is in operation (block 810). The utilization data may be received by the process 800 executed at a cloud server communicatively coupled with the network device via a wired or a wireless network. The utilization data may include one or more functional parameters, or one or more physical parameters related to the working of the set of components. The utilization data may also include data regarding environmental factors of the network device, such as a pressure, a humidity, an altitude, a temperature, or a geographical location. The utilization data may also include any user-defined criteria.

In a number of embodiments, the process 800 may assess a valuation of each of the set of components across each of one or more valuation categories (block 820). The one or more valuation categories may include a use time value category, a mechanical value category, or a user-defined value category. The valuation of the network device may be determined as a function of original value of the network device and component valuations across various valuation categories.

In a variety of embodiments, the process 800 may determine a valuation of the network device based on the assessed valuations of each of the set of components (block 830). The process 800 may assess the valuation of each of the set of components across each of the one or more valuation categories. The process 800 may select a minimum value from the valuation of each of the one or more valuation categories for each of the set of components. In more embodiments, the process 800 may apply an aggregation function on the valuation across each of the one or more valuation categories. Thus, the process 800 may obtain an intermediate valuation for each of the set of components based on applying the aggregation function. In further embodiments, the process 800 may determine the valuation of the network device based on the intermediate valuation obtained for each of the set of components.

In more embodiments, the process 800 may transmit the valuation of the network device to a graphical user interface (GUI) of a user device (block 840). The process 800 may transmit the valuation of the network device to a user device for quick evaluation by a network operator. In still more embodiments, the process 800 may check whether new utilization data is received for the set of components (block 845). If the new utilization data is received for the set of components, in still further embodiments, the process 800 may update the assessed valuation of each of the set of components across each of the one or more valuation categories (block 850). As the new utilization data may pertain to each of the set of components, the valuation across each of the one or more valuation categories may need to be updated.

In still additional embodiments, the process 800 may update the valuation of the network device (block 860). Based on the updated valuation of each of the set of components, the updated valuation of the network device may be determined as an aggregate of the valuation of each of the set of components. The process 800, in yet more embodiments, may transmit the updated valuation to the GUI of the user device. However, if no new utilization data for the set of components is received, the process 800 may continue to monitor whether new utilization data is received (block 845).

Although a specific embodiment showing a process for determining the valuation of a network device suitable for carrying out the various steps, processes, methods, and operations described herein is discussed with respect to FIG. 8, any of a variety of systems and/or processes may be utilized in accordance with embodiments of the disclosure. In yet more embodiments, the process 800 may select only the components having higher degree of utilization, high valued components, or components with high probability of failure for determining the valuation of the network device. For example, the process 800 may select only the CPU cores and fan to determine the valuation of the network device, whereas may not select the components such as LED, flash disk, power supply, etc. The elements depicted in FIG. 8 may also be interchangeable with other elements of FIGS. 1-7 and 9 as required to realize a particularly desired embodiment.

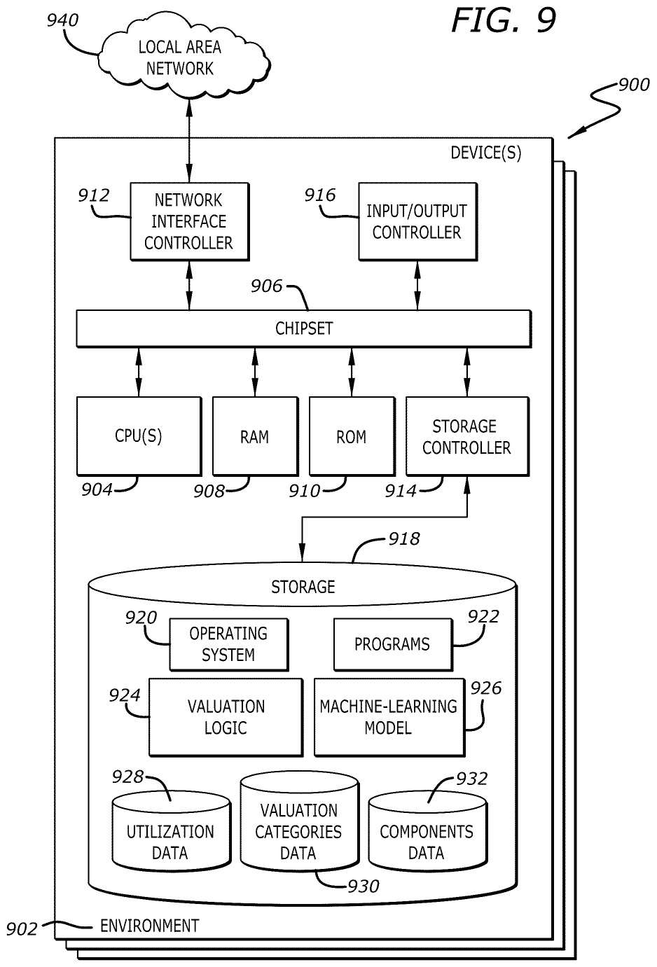

Referring to FIG. 9, a conceptual block diagram of a device 900 suitable for configuration with a valuation logic in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, utilization data 928, valuation categories data 930, and components data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In many examples, the operations performed by a cloud computing network, and or any components included therein, may be supported by one or more devices similar to the device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In many examples, the virtualization layer may be supported by a hypervisor that provides one or more virtual machines running on the device 900 to perform functions described herein. The virtualization layer may generally support a virtual resource that performs at least a portion of the techniques described herein.

In many further embodiments, the device 900 may include valuation logic 924. The valuation logic 924 can be configured to perform one or more of the various steps, processes, operations, and/or other methods that are described above. Often, the valuation logic 924 can be a set of instructions stored within a non-volatile memory that, when executed by the processor(s)/controller(s) 904 can carry out these steps, etc. The valuation logic 924 may determine the remaining useful life and valuation of the device 900. In some embodiments, the valuation logic 924 may be a client application that resides on a network-connected device, such as, but not limited to, a server, switch, personal or mobile computing device in a single or distributed arrangement. The valuation logic 924 may determine the remaining useful life and valuation of a network device operating in a networking environment. The valuation logic 924 may include one or more valuation categories and one or more aggregation functions using which the remaining useful life and the valuation of the network device may be determined.

In many embodiments, the utilization data 928 may include data related to one or more functional parameters or one or more physical parameters of a set of components of the device 900 or other connected network devices. The functional parameters may include parameters such as a power up time period, a product up time period, an over-heat temperature alarm time period, or the like. The physical parameters may include parameters such as a count of insertion and removal instances of the component, a count of rotations of the component, a rotation time period of the component, or the like. In several more embodiments, the utilization data 928 may include data related to at least one or more environmental factors or user-defined criteria. The one or more environmental factors may include a pressure, a humidity, an altitude, a temperature, or a geographical location of the component. The user-defined criteria may include specific conditions set by network operator or network administrator such as specified downtime for scheduled maintenance, selecting components with higher bill of material (BOM), selecting a combination of aggregation functions for a specific component, or the like. In an example scenario, as per the user-defined criteria, the valuation logic 924 may select a minimum function as the aggregation function to determine the valuation of fan. In several embodiments, the utilization data 928 may be collected by a data recorder residing on a secure vault of a CPU, microcontroller, custom silicon, FPGA, a cloud server, or the like.

In a number of embodiments, the valuation categories data 930 may include a use time value category, a mechanical value category, or a user-defined value category. The use time value category may refer to valuation of the device 900 based on utilization of the set of components of the device 900. For example, the use time value may depend on the total device up time, such that a device having greater number of total up time can have lower use time value as the remaining useful life may be less compared to a device having comparatively lesser number of total up time. In numerous embodiments, the valuation categories data 930 may store definition of different categories for different components. In several more embodiments, the valuation of the device 900 may be determined as a function of original value of the device 900 and at least one valuation category.

In some embodiments, the components data 932 may include various internal components of the device 900 such as a fan, a power supply, CPU cores, transceiver, flash disk, battery, or the like. The components data 932, in yet more embodiments, may also include serial number, identification number, manufacturing details, year of manufacture, etc. of the components of the device 900.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more linear regression models, logistic regression models, decision trees, Naïve Bayes models, neural networks, k-means cluster models, random forest models, and/or other types of ML models 926. The ML model 926 may be configured to predict valuation of the device 900 based on selection of one or more utilization data 928 according to the components selected.

The ML model(s) 926 can be configured to generate inferences to make predictions or draw conclusions from data. An inference can be considered the output of a process of applying a model to new data. This can occur by learning from at least the subscription data 928, the drop rule data 930, and the filtering ruleset data 932, and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for the device 900 suitable for configuration with the valuation logic 924 for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Information Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

1. A network device, comprising:
a set of components;
a processor; and
a memory communicatively coupled to the processor, wherein the memory comprises a valuation logic that is configured to:
collect utilization data reflecting operational usage of the set of components while the network device remains operational within a network environment;
assess, based on the utilization data, an individual component valuation for each of the set of components across each of one or more predefined valuation categories, wherein the individual component valuation reflects a condition of the respective component derived from the operational usage; and
determine a non-disruptive valuation of the network device as a function of the individual component valuations assessed across at least one of the one or more predefined valuation categories for each respective component.

2. The network device of claim 1, wherein the valuation of the network device corresponds to an aggregate of the valuation of each of the set of components.

3. The network device of claim 2, wherein determining the valuation of the network device comprises selecting, for each of the set of components, a minimum value from the valuation across each of the one or more valuation categories, wherein the valuation of the network device is determined based on the selected valuation for each of the set of components.

4. The network device of claim 2, wherein determining the valuation of the network device comprises:
applying, for each of the set of components, an aggregation function on the valuation across each of the one or more valuation categories; and
obtaining an intermediate valuation for each of the set of components based on applying the aggregation function, wherein the valuation of the network device is determined based on the intermediate valuation obtained for each of the set of components.

5. The network device of claim 4, wherein the aggregation function comprises at least one of: a sum function, an average function, or a maximum function.

6. The network device of claim 2, wherein the valuation logic is further configured to transmit the valuation of the network device to a graphical user interface (GUI) of a user device.

7. The network device of claim 1, wherein the one or more valuation categories comprises at least one of: a use time value category, a mechanical value category, or a user-defined value category.

8. The network device of claim 1, wherein the utilization data of a component of the set of components comprises data associated with one or more functional parameters of the component.

9. The network device of claim 8, wherein the one or more functional parameters of the component comprise at least one of: a power up time period, a product up time period, or an over-heat temperature alarm time period.

10. The network device of claim 1, wherein the utilization data of a component of the set of components comprises data related to one or more physical parameters of the component.

11. The network device of claim 10, wherein the utilization data of a component of the set of components comprises at least one of: a count of insertion and removal instances of the component, a count of rotations of the component, or a rotation time period of the component.

12. The network device of claim 1, wherein the utilization data of a component of the set of components comprises data related to at least one of one or more environmental factors or user-defined criteria.

13. The network device of claim 12, wherein the one or more environmental factors comprise at least one of: a pressure, a humidity, an altitude, a temperature, or a geographical location of the component.

14. The network device of claim 1, wherein the valuation logic is further configured to:
receive new utilization data for the set of components; and
update, based on the new utilization data, the assessed valuation of each of the set of components across each of the one or more valuation categories.

15. The network device of claim 14, wherein the valuation logic is further configured to update the valuation of the network device based on the updated valuation of each of the set of components across each of the one or more valuation categories.

16. The network device of claim 1, wherein the valuation logic is further configured to utilize a machine learning model to assess the valuation of each of the set of components across each of the one or more valuation categories.

17. The network device of claim 1, wherein the valuation logic is further configured to:
assess a use condition of each of the set of components based on the utilization data; and
determine a remaining useful life of the network device based on the use condition of each of the set of components.

18. The network device of claim 1, wherein the valuation logic is further configured to determine the valuation of the network device while the network device is in operation deployed in a networking system or environment.

19. A device, comprising:
a processor;
a transceiver communicatively coupled to a network device, wherein the network device comprises a set of components; and
a memory communicatively coupled to the processor, wherein the memory comprises a valuation logic that is configured to:
receive utilization data of the set of components while the network device remains operational within a network environment;
assess, based on the received utilization data, a valuation of each of the set of components across each of one or more valuation categories wherein the individual component valuation reflects a condition of the respective component derived from the operational usage; and
determine a non-disruptive valuation of the network device, while the network device is in operation, as a function of the individual component valuations assessed across each of the one or more predefined valuation categories.

20. A method comprising:
collecting utilization data reflecting operational usage of a set of components of a network device while the network device remains operational within a network environment;
assessing, based on the utilization data, an individual component valuation of each of the set of components across each of one or more predefined valuation categories wherein the individual component valuation reflects a condition of the respective component derived from the operational usage; and
determining a non-disruptive valuation of the network device based on the individual component valuations assessed valuation of each of the set of components across at least one of the one or more predefined valuation categories for each respective component.
